(19) United States
(12) Patent Application Publication
(10) Pub. No.: US 2015/0004911 A1
(43) Pub. Date: Jan. 1, 2015

(54) PROVIDING PROFILE CONNECTION NOTIFICATIONS

(71) Applicant: Toyota Motor Engineering & Manufacturing North America, Inc., Erlanger, KY (US)

(72) Inventor: Eric Randell Schmidt, Northville, MI (US)

(21) Appl. No.: 13/932,361

(22) Filed: Jul. 1, 2013

(51) Int. Cl. H04L 29/06; H04B 7/26

(52) U.S. Cl. CPC H04L 65/1069; H04B 7/26
USPC 455/41.2

(57) ABSTRACT

A method for providing profile connection notifications is provided. A profile connection can be, for example, a Bluetooth profile session, such as a Message Access Profile session, a Phone Book Access Profile session, or the like. The method includes establishing a Bluetooth connection with a mobile device, attempting to open a profile session with the mobile device, and determining that the profile session has not been opened. Responsive to determining that the profile session has not been opened, the method further includes causing a notification to be displayed. The notification provides information about an action to be taken by a user.

### FIELD

Embodiments provided herein generally describe connections between devices and, more specifically, methods, systems and vehicles that provide profile connection notifications.

### BACKGROUND

Display devices, such as vehicle display devices can be used to display information to users. Information may include navigation data, vehicle system settings, or information provided by a mobile device that is communicatively coupled to the vehicle display device. When the vehicle display device is coupled to a mobile device, users can send and receive messages, make calls, and utilize other mobile device functionality through the via the vehicle display device.

When a user's mobile device and the vehicle display system are communicatively coupled, such as via a Bluetooth profile connection, the vehicle display system can access information on the user's mobile device. In some instances, the vehicle display system can request access to information that is personal or potentially sensitive. In order to protect the user's information, the mobile device can prompt the user to confirm that the vehicle display system has permission to access the information. Typically, the prompt is displayed on the mobile device, where the user may not notice the prompt because the user is instead focused on the vehicle display. Accordingly, the connection may not be successful, and the user may not understand why.

### SUMMARY

In one embodiment, a method for providing profile connection notifications is provided. The method includes establishing a Bluetooth connection with a mobile device, attempting to open a profile session with the mobile device, and determining that the profile session has not been opened. Responsive to determining that the profile session has not been opened, the method further includes causing a notification to be displayed. The notification provides information about an action to be taken by a user.

In another embodiment, a system for providing profile connection notifications is provided. The system includes one or more processors, one or more memory modules communicatively coupled to the one or more processors, a display, and machine readable instructions stored in the one or more memory modules. When executed by the one or more processors, the machine readable instructions cause the system to attempt to open a profile session with a mobile device, determine that the profile session has not been opened within a period of time, and cause a notification to be displayed on the display.

In yet another embodiment, a vehicle includes one or more processors, one or more memory modules, and machine readable instructions stored in the one or more memory modules. The machine readable instructions, when executed by the one or more processors, cause the vehicle to establish a Bluetooth connection with a mobile device, attempt to open a profile session with the mobile device, and, responsive to the profile session with the mobile device not being opened within a period of time, cause a notification to be displayed.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a vehicle user interface including physical controls, sensors communicating with a processor, and a display device according to one or more embodiments herein;

FIG. 2 illustrates a speech recognition and display system according to one or more embodiments herein;

FIG. 3 illustrates an example method for establishing a connection between a mobile device and an in-vehicle system according to one or more embodiments herein;

FIG. 4 illustrates an example method for providing profile connection notifications in accordance with one or more embodiments herein; and

FIG. 5 illustrates an example method for establishing a profile connection between a speech recognition and display system and a mobile device in accordance with one or more embodiments.

### DETAILED DESCRIPTION

Various embodiments described herein relate to methods, systems, and vehicles for providing profile connection notifications. In various embodiments, upon establishing a Bluetooth connection with a mobile device, a speech recognition and display system can attempt to open a profile session with the mobile device. Any number of profile sessions can be opened to allow exchange of information between the mobile device and the speech recognition and display system to enable various functions (e.g., messaging, calling, etc.) to be performed. For example, Phone Book Access Profile (PBAP) allows exchange of phone book objects between devices. Phone book objects represent information about one or more contacts stored by the mobile device. Such a profile can allow the speech recognition and display system to display a name of a caller when an incoming call is received, and to download the phone book so that the user can initiate a call from a vehicle display. As another example, Message Access Profile (MAP) allows exchange of messages between the mobile device and the speech recognition and display system. MAP can enable users to read messages (e.g., SMS messages, emails, and the like) on the display and create messages using the speech recognition and display system. Various embodiments of the methods, systems, and vehicles for providing profile connection notifications are described in further detail below.

Because profile sessions can allow exchange of information that can be personal and/or potentially sensitive, in various embodiments, the mobile device can prompt the user to confirm that the profile session is permitted to be established and the information can be shared. When the speech recognition and display system determines that a profile session has not been successfully opened within a period of time, such as because the user has not confirmed that the profile session is permitted, the speech recognition and display system can cause a notification to be displayed to the user. The notification can provide information about an action to be taken by the user.

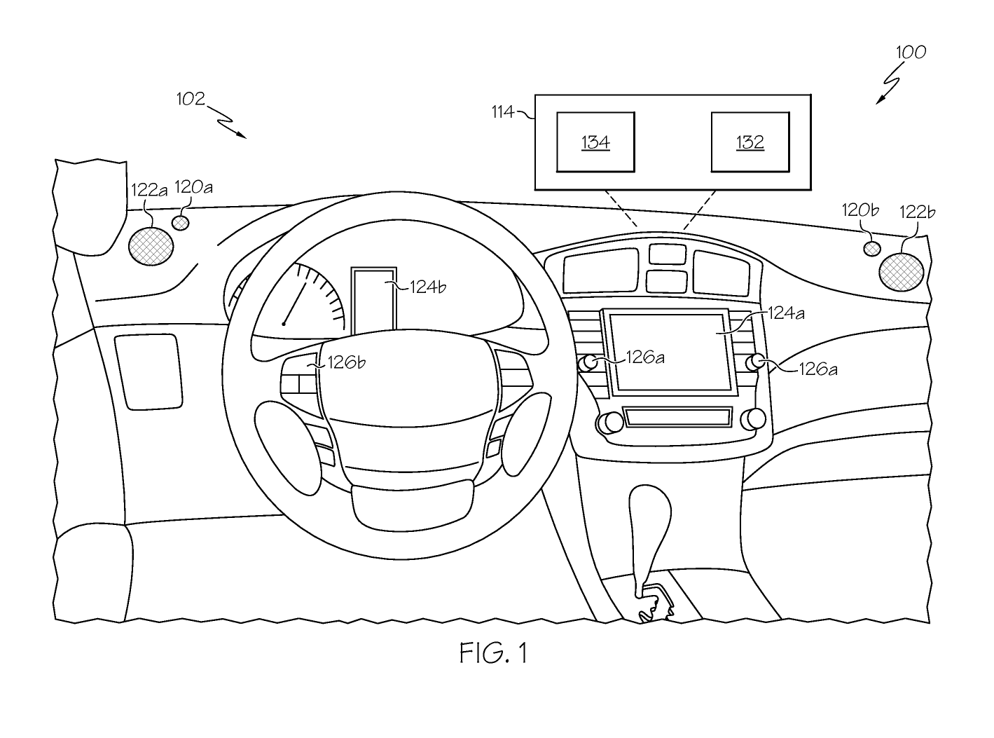

Referring now to the drawings, FIG. 1 schematically depicts a speech recognition and display system 100 in an interior portion of a vehicle 102 for providing a vehicle user interface that includes message information, according to embodiments disclosed herein. As illustrated, the vehicle 102 includes a number of components that can provide input to or output from the speech recognition and vehicle display systems described herein. The interior portion of the vehicle 102 includes a console display 124a and a dash display 124b (referred to independently and/or collectively herein as “display 124”). The console display 124a can be configured to provide one or more user interfaces and can be configured as a touch screen and/or include other features for receiving user input. The dash display 124b can similarly be configured to provide one or more interfaces, but often the data provided in the dash display 124b is a subset of the data provided by the console display 124a. Regardless, at least a portion of the user interfaces depicted and described herein is provided on either or both the console display 124a and the dash display 124b. The vehicle 102 also includes one or more microphones 120a, 120b (referred to independently and/or collectively herein as “microphone 120”) and one or more speakers 122a, 122b (referred to independently and/or collectively herein as “speaker 122”). The microphones 120a, 120b are configured for receiving user voice commands and/or other inputs to the speech recognition systems described herein. Similarly, the speakers 122a, 122b can be utilized for providing audio content from the speech recognition system to the user. The microphone 120, the speaker 122, and/or related components are part of an in-vehicle audio system. The vehicle 102 also includes tactile input hardware 126a and/or peripheral tactile input 126b for receiving tactile user input, as will be described in further detail below.

The vehicle 102 also includes a vehicle computing device 114 that can provide computing functions for the speech recognition and display system 100. The vehicle computing device 114 can include a processor 132 and a memory component 134, which may store message account information.

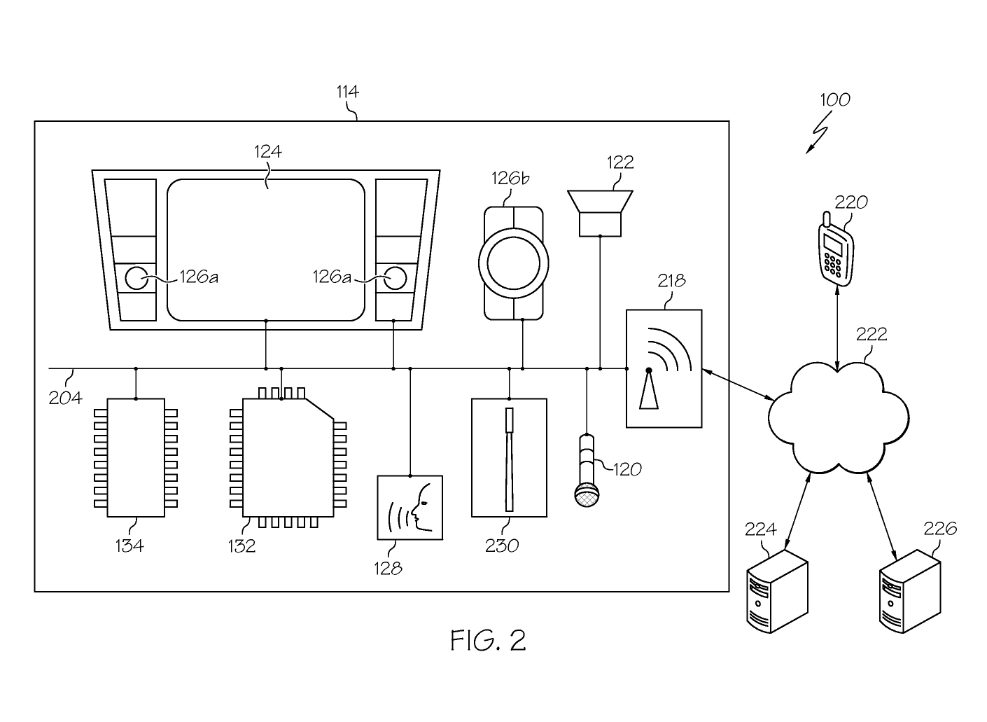

Referring now to FIG. 2, an embodiment of the speech recognition and display system 100, including a number of the components depicted in FIG. 1, is schematically depicted. It should be understood that all or part of the speech recognition and display system 100 may be integrated with the vehicle 102 or may be embedded within a mobile device (e.g., smartphone, laptop computer, etc.) carried by a driver of the vehicle.

The speech recognition and display system 100 includes one or more processors 132, a communication path 204, the memory component 134, a display 124, a speaker 122, tactile input hardware 126a, a peripheral tactile input 126b, a microphone 120, network interface hardware 218, and a satellite antenna 230. The various components of the speech recognition and display system 100 and the interaction thereof will be described in detail below.

As noted above, the speech recognition and display system 100 includes the communication path 204. The communication path 204 may be formed from any medium that is capable of transmitting a signal such as, for example, conductive wires, conductive traces, optical waveguides, or the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 204 communicatively couples the various components of the speech recognition and display system 100. As used herein, the term “communicatively coupled” means that coupled components are capable of exchanging data signals with one another such as, for example, electrical signals via conductive medium, electromagnetic signals via air, optical signals via optical waveguides, and the like.

As noted above, the speech recognition and display system 100 includes the processor 132. The processor 132 can be any device capable of executing machine readable instructions. Accordingly, the processor 132 may be a controller, an integrated circuit, a microchip, a computer, or any other computing device. The processor 132 is communicatively coupled to the other components of the speech recognition and display system 100 by the communication path 204. Accordingly, the communication path 204 may communicatively couple any number of processors with one another, and allow the modules coupled to the communication path 204 to operate in a distributed computing environment. Specifically, each of the modules can operate as a node that may send and/or receive data.

As noted above, the speech recognition and display system 100 includes the memory component 134 which is coupled to the communication path 204 and communicatively coupled to the processor 132. The memory component 134 may comprise RAM, ROM, flash memories, hard drives, or any device capable of storing machine readable instructions such that the machine readable instructions can be accessed and executed by the processor 132. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the memory component 134. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

In some embodiments, the memory component 134 includes one or more speech recognition algorithms, such as an automatic speech recognition engine that processes speech input signals received from the microphone 120 and/or extracts speech information from such signals. Furthermore, the memory component 134 includes machine readable instructions that, when executed by the processor 132, cause the speech recognition and display system to perform the actions described below.

Still referring to FIG. 2, as noted above, the speech recognition and display system 100 comprises the display 124 for providing visual output such as, for example, information, entertainment, maps, navigation, messages, or a combination thereof. The display 124 is coupled to the communication path 204 and communicatively coupled to the processor 132. Accordingly, the communication path 204 communicatively couples the display 124 to other modules of the speech recognition and display system 100. The display 124 can include any medium capable of transmitting an optical output such as, for example, a cathode ray tube, light emitting diodes, a liquid crystal display, a plasma display, or the like. Moreover, in some embodiments, the display 124 is a touchscreen that, in addition to providing optical information, detects the presence and location of a tactile input upon a surface of or adjacent to the display. Accordingly, each display may receive mechanical input directly upon the optical output provided by the display 124. Additionally, it is noted that the display 124 can include at least one of the processor 132 and the memory component 134. While the speech recognition and display system 100 is illustrated as a single, integrated system in FIG. 2, in other embodiments, the speech recognition and display systems can be independent systems, such as embodiments in which the speech recognition system audibly provides outback or feedback via the speaker 122.

As noted above, the speech recognition and display system 100 includes the speaker 122 for transforming data signals from the speech recognition and display system 100 into mechanical vibrations, such as in order to output audible prompts or audible information from the speech recognition and display system 100. The speaker 122 is coupled to the communication path 204 and communicatively coupled to the processor 132. However, it should be understood that in other embodiments, the speech recognition and display system 100 may not include the speaker 122, such as in embodiments in which the speech recognition and display system 100 does not output audible prompts or audible information, but instead visually provides output via the display 124.

Still referring to FIG. 2, as noted above, the speech recognition and display system 100 comprises the tactile input hardware 126a coupled to the communication path 204 such that the communication path 204 communicatively couples the tactile input hardware 126a to other modules of the speech recognition and display system 100. The tactile input hardware 126a can be any device capable of transforming mechanical, optical, or electrical signals into a data signal capable of being transmitted with the communication path 204. Specifically, the tactile input hardware 126a can include any number of movable objects that each transform physical motion into a data signal that can be transmitted to over the communication path 204 such as, for example, a button, a switch, a knob, a microphone or the like. In some embodiments, the display 124 and the tactile input hardware 126a are combined as a single module and operate as an audio head unit or an infotainment system. However, it is noted, that the display 124 and the tactile input hardware 126a can be separate from one another and operate as a single module by exchanging signals via the communication path 204. While the speech recognition and display system 100 includes the tactile input hardware 126a in the embodiment depicted in FIG. 2, the speech recognition and display system 100 may not include the tactile input hardware 126a in other embodiments, such as embodiments that do not include the display 124.

As noted above, the speech recognition and display system 100 optionally comprises the peripheral tactile input 126b coupled to the communication path 204 such that the communication path 204 communicatively couples the peripheral tactile input 126b to other modules of the speech recognition and display system 100. For example, in one embodiment, the peripheral tactile input 126b is located in a vehicle console to provide an additional location for receiving input. The peripheral tactile input 126b operates in a manner substantially similar to the tactile input hardware 126a, i.e., the peripheral tactile input 126b includes movable objects and transforms motion of the movable objects into a data signal that may be transmitted over the communication path 204.

As noted above, the speech recognition and display system 100 comprises the microphone 120 for transforming acoustic vibrations received by the microphone into a speech input signal. The microphone 120 is coupled to the communication path 204 and communicatively coupled to the processor 132. As will be described in further detail below, the processor 132 may process the speech input signals received from the microphone 120 and/or extract speech information from such signals.

As noted above, the speech recognition and display system 100 includes the network interface hardware 218 for communicatively coupling the speech recognition and display system 100 with the mobile device 220 or a computer network. The network interface hardware 218 is coupled to the communication path 204 such that the communication path 204 communicatively couples the network interface hardware 218 to other modules of the speech recognition and display system 100. The network interface hardware 218 can be any device capable of transmitting and/or receiving data via a wireless network. Accordingly, the network interface hardware 218 can include a communication transceiver for sending and/or receiving data according to any wireless communication standard. For example, the network interface hardware 218 can include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. In some embodiments, the network interface hardware 218 includes a Bluetooth transceiver that enables the speech recognition and display system 100 to exchange information with the mobile device 220 (e.g., a smartphone) via Bluetooth communication.

Still referring to FIG. 2, data from various applications running on the mobile device 220 can be provided from the mobile device 220 to the speech recognition and display system 100 via the network interface hardware 218. The mobile device 220 can be any device having hardware (e.g., chipsets, processors, memory, etc.) for communicatively coupling with the network interface hardware 218 and a cellular network 222. Specifically, the mobile device 220 can include an antenna for communicating over one or more of the wireless computer networks described above. Moreover, the mobile device 220 can include a mobile antenna for communicating with the cellular network 222. Accordingly, the mobile antenna may be configured to send and receive data according to a mobile telecommunication standard of any generation (e.g., 1G, 2G, 3G, 4G, 5G, etc.). Specific examples of the mobile device 220 include, but are not limited to, smart phones, tablet devices, e-readers, laptop computers, or the like.

The cellular network 222 generally includes a plurality of base stations that are configured to receive and transmit data according to mobile telecommunication standards. The base stations are further configured to receive and transmit data over wired systems such as public switched telephone network (PSTN) and backhaul networks. The cellular network 222 can further include any network accessible via the backhaul networks such as, for example, wide area networks, metropolitan area networks, the Internet, satellite networks, or the like. Thus, the base stations generally include one or more antennas, transceivers, and processors that execute machine readable instructions to exchange data over various wired and/or wireless networks.

Accordingly, the cellular network 222 can be utilized as a wireless access point by the mobile device 220 to access one or more servers (e.g., a first server 224 and/or a second server 226). The first server 224 and the second server 226 generally include processors, memory, and chipset for delivering resources via the cellular network 222. Resources can include providing, for example, processing, storage, software, and information from the first server 224 and/or the second server 226 to the speech recognition and display system 100 via the cellular network 222. Additionally, it is noted that the first server 224 or the second server 226 can share resources with one another over the cellular network 222 such as, for example, via the wired portion of the network, the wireless portion of the network, or combinations thereof.

Still referring to FIG. 2, the one or more servers accessible by the speech recognition and display system 100 via the communication link of the mobile device 220 to the cellular network 222 can include third party servers that provide additional speech recognition capability. For example, the first server 224 and/or the second server 226 can include speech recognition algorithms capable of recognizing more words than the local speech recognition algorithms stored in the memory component 134. It should be understood that the mobile device 220 may be communicatively coupled to any number of servers by way of the cellular network 222.

As noted above, the speech recognition and display system 100 optionally includes a satellite antenna 230 coupled to the communication path 204 such that the communication path 204 communicatively couples the satellite antenna 230 to other modules of the speech recognition and display system 100. The satellite antenna 230 is configured to receive signals from global positioning system satellites. Specifically, in one embodiment, the satellite antenna 230 includes one or more conductive elements that interact with electromagnetic signals transmitted by global positioning system satellites. The received signal is transformed into a data signal indicative of the location (e.g., latitude and longitude) of the satellite antenna 230 or an object positioned near the satellite antenna 230, by the processor 132. Additionally, it is noted that the satellite antenna 230 can include at least one processor 132 and the memory component 134. In embodiments where the speech recognition and display system 100 is coupled to a vehicle, the processor 132 executes machine readable instructions to transform the global positioning satellite signals received by the satellite antenna 230 into data indicative of the current location of the vehicle. While the speech recognition and display system 100 includes the satellite antenna 230 in the embodiment depicted in FIG. 2, the speech recognition and display system 100 may not include the satellite antenna 230 in other embodiments, such as embodiments in which the speech recognition and display system 100 does not utilize global positioning satellite information or embodiments in which the speech recognition and display system 100 obtains global positioning satellite information from the mobile device 220 via the network interface hardware 218.

Still referring to FIG. 2, it should be understood that the speech recognition and display system 100 can be formed from a plurality of modular units, i.e., the display 124, the speaker 122, the tactile input hardware 126a, the peripheral tactile input 126b, the microphone 120, etc. can be formed as modules that when communicatively coupled form the speech recognition and display system 100. Accordingly, in some embodiments, each of the modules can include at least one processor 132 and/or the memory component 134. Accordingly, it is noted that, while specific modules may be described herein as including a processor and/or a memory module, the embodiments described herein can be implemented with the processors and memory modules distributed throughout various communicatively coupled modules.

Having described in detail a speech recognition and display system that can be used to implement one or more embodiments, consider the following methods for providing profile connection notifications.

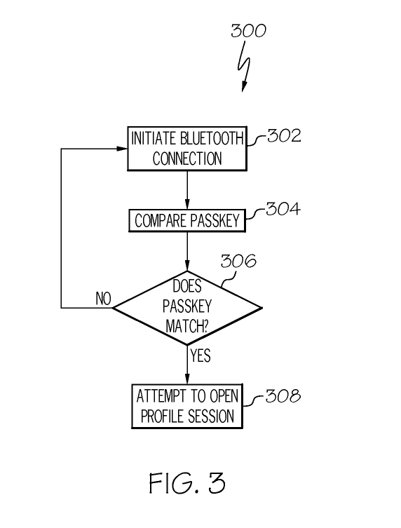

Turning now to FIG. 3, an example method 300 for communicatively coupling the mobile device 220 and the speech recognition and display system 100 via a Bluetooth connection is illustrated.

First, at block 302, a Bluetooth connection between the mobile device 220 and the speech recognition and display system 100 is initiated. For example, the mobile device 220 can initiate a search for an available Bluetooth device, such as the speech recognition and display system 100. In some embodiments, the mobile device 220 initiates the connection automatically, while in other embodiments, the mobile device 220 initiates the connection in response to receiving user input. For example, the user can access a Bluetooth connection menu and indicate that a connection should be initiated. Alternatively, the speech recognition and display system 100 can initiate the connection, either automatically or in response to receiving user input.

Next, passkeys are compared (block 304). For example, the speech recognition and display system 100 can have a passkey or pairing code that enables the user to connect the mobile device 220 to the speech recognition and display system 100. In some embodiments, the user is prompted to input the passkey, while in other embodiments, the passkey was previously stored.

If the passkeys do not match (a no at block 306), the method can return to block 302 and attempt to initiate another Bluetooth connection. For example, if the user inputs a passkey into the mobile device 220 that does not match the passkey for the speech recognition and display system 100, the connection between the mobile device 220 and the speech recognition and display system 100 will not be established, and the mobile device 220 can attempt to initiate another connection automatically or in response to input from the user. In some embodiments, the user is prompted to re-enter the passkey.

However, if the passkey does match (a yes at block 306), the Bluetooth connection is established, and the speech recognition and display system 100 can attempt to open one or more profile sessions (block 308). As described above, any number of profile sessions can be opened to allow exchange of information between the mobile device 220 and the speech recognition and display system 100 to enable various functions (e.g., messaging, calling, etc.) to be performed. For example, the Phone Book Access Profile (PBAP) allows exchange of phone book objects between devices. Phone book objects represent information about one or more contacts stored by the mobile device 220. Such a profile can allow the speech recognition and display system 100 to display a name of a caller when an incoming call is received, and to download the phone book so that the user can initiate a call from the display 124. As another example, the Message Access Profile (MAP) allows exchange of messages between the mobile device 220 and the speech recognition and display system 100. MAP can enable users to read messages (e.g., SMS messages, emails, and the like) on the display 124 and create messages using the speech recognition and display system 100. Additional profiles are available and will be apparent to one skilled in the art.

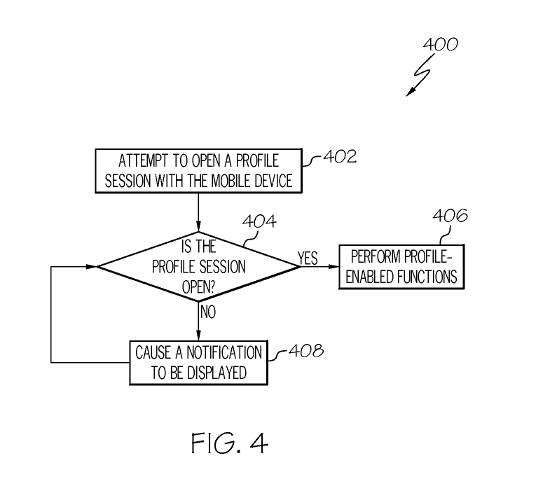

FIG. 4 illustrates an example method 400 for providing profile connection notifications. In various embodiments, the method 400 is implemented by the speech recognition and display system 100.

First, at block 402, the speech recognition and display system 100 attempts to open a profile session with the mobile device 220. This can be performed in any suitable way, examples of which are discussed in detail below.

Next, at block 404, the speech recognition and display system 100 determines if the profile session is open. The speech recognition and display system 100 can determine if the profile session is open, for example, by attempting to perform a function enabled by the profile session or by determining if a confirmation from the mobile device 220 has been received. In various embodiments, the speech recognition and display system 100 determines if the profile session is open within a predetermined period of time. For example, the predetermined period of time can be about five seconds. Accordingly, the speech recognition and display system 100 can determine if the profile session is open within about five seconds from a time associated with the attempt to open the profile session at block 402. In some embodiments, the period of time is less than a failure duration indicative of the failure of the profile connection.

If the profile session is opened (e.g., a yes at block 404), at block 406, the speech recognition and display system 100 can perform profile-enabled functions. For example, the speech recognition and display system 100 can access messages received by the mobile device 220, download phone book objects from the mobile device 220, and the like. The functions that are enabled depend on the particular profile session opened between the speech recognition and display system 100 and the mobile device 220.

However, if the speech recognition and display system 100 determines that the profile session has not been opened within the period of time (e.g., a no at block 404), the speech recognition and display system 100 causes a notification to be displayed (block 408) on the display 124. In various embodiments, the notification provides information about an action to be taken by the user. For example, the notification can prompt the user to provide permission via a user input or other indication to open the profile session. In various embodiments, the notification indicates that the action should be taken on the mobile device 220. For example, the notification can indicate that the user should provide input to the mobile device 220 in order to provide permission to open the profile session.

After the speech recognition and display system 100 causes the notification to be displayed, the method 400 can return to block 404 and the speech recognition and display system 100 can again determine if the profile session is open. In various embodiments, the speech recognition and display system 100 determines that the profile session has been opened (e.g., a yes at block 404) subsequent to causing the notification to be displayed, and performs profile-enabled functions (block 406).

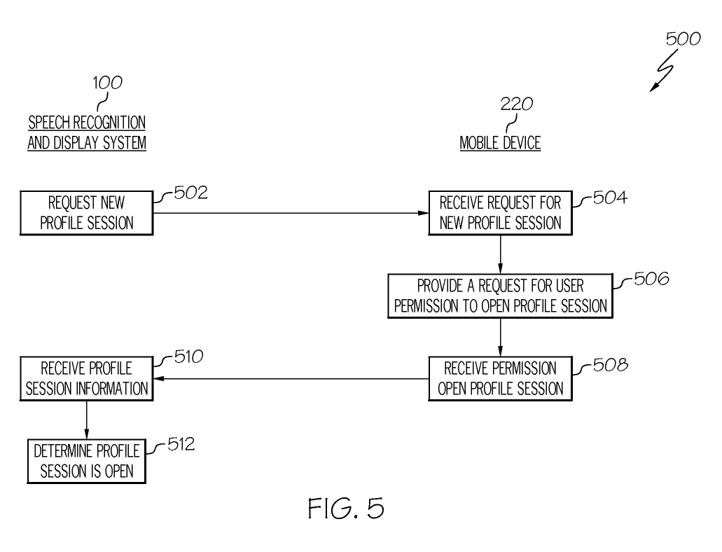

Turning now to FIG. 5, an example method 500 for establishing a profile connection is illustrated. As illustrated in FIG. 5, method 500 includes various functions that are performed by the speech recognition and display system 100, and various functions that are performed by the mobile device 220. In some embodiments, however, functions can be performed either of the speech recognition and display system 100 or the mobile device 220.

Once a Bluetooth connection is established, the speech recognition and display system 100 requests a new profile session (block 502). The request is received by the mobile device 220 (block 504). In various embodiments, such as when the profile session enables sharing of personal and/or potentially sensitive information, the mobile device 220 provides a request for user permission to open the profile session (block 506). In some embodiments, the mobile device 220 can prompt the user to confirm that information can be shared with the speech recognition and display system 100. When the mobile device 220 receives permission to open the profile session (block 508), profile session information is transmitted to the speech recognition and display system 100.

The speech recognition and display system 100 receives the profile session information at block 510, and determines that the profile session is open (block 512). In various embodiments, until the speech recognition and display system 100 receives the profile session information, the speech recognition and display system 100 will determine that the profile session is not open. Accordingly, if the profile session information is not received within the period of time (e.g., about five seconds), the speech recognition and display system 100 causes a notification to be displayed in accordance with the embodiments described in FIG. 4.

Various embodiments described herein enable the speech recognition and display system 100 to provide profile connection notifications to a user when a profile session is not opened within a period of time. The speech recognition and display system 100 can notify the user that an additional action may be required to open the profile session when the user might not otherwise be aware such an additional action is required. For example, the speech recognition and display system 100 can indicate that the user should refer to the mobile device 220 that is waiting for the user to indicate that permission is granted to establish the connection. Accordingly, the speech recognition and display system 100 can provide guidance to the user to enable the profile session to be opened. This guidance can reduce the likelihood that a profile connection fails and the user does not understand why.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
establishing a Bluetooth connection with a mobile device;
attempting to open a profile session with the mobile device;
determining that the profile session has not been opened; and
responsive to determining that the profile session has not been opened, causing a notification to be displayed, wherein the notification provides information about an action to be taken by a user.

2. The method of claim 1, wherein the profile session is a Message Access Profile session.

3. The method of claim 1, wherein the profile session is a Phone Book Access Profile session.

4. The method of claim 1, wherein the action to be taken by the user comprises providing permission to open the profile session.

5. The method of claim 1, wherein the determining that the profile session has not been opened comprises determining that the profile session has not been opened within a period of time from a time associated with the attempting to open the profile session.

6. The method of claim 5, wherein the period of time is less than a profile failure duration.

7. The method of claim 1, further comprising:
determining that the profile session has been opened subsequent to causing the notification to be displayed.

8. A system comprising:
one or more processors;
one or more memory modules communicatively coupled to the one or more processors;
a display; and
machine readable instructions stored in the one or more memory modules that cause the system to perform at least the following when executed by the one or more processors:
attempt to open a profile session with a mobile device;
determine that the profile session has not been opened within a period of time; and
responsive to determining that the profile session has not been opened within the period of time, cause a notification to be displayed on the display.

9. The system of claim 8, wherein the notification indicates an action should be taken on the mobile device.

10. The system of claim 9, wherein the action comprises providing permission to open the profile session.

11. The system of claim 8, wherein the profile session is one of a Message Access Profile session and a Phone Book Access Profile session.

12. The system of claim 8, wherein the period of time is about five seconds.

13. The system of claim 8, wherein the machine readable instructions stored in the one or more memory modules that further cause the system to perform at least the following when executed by the one or more processors:
establish a Bluetooth connection with the mobile device prior to attempting to open the profile session.

14. A vehicle comprising:
one or more processors;
one or more memory modules communicatively coupled to the one or more processors; and
machine readable instructions stored in the one or more memory modules that cause the vehicle to perform at least the following when executed by the one or more processors:
establish a Bluetooth connection with a mobile device;
attempt to open a profile session with the mobile device; and
responsive to the profile session with the mobile device not being opened within a period of time, cause a notification to be displayed.

15. The vehicle of claim 14, wherein the period of time is about five seconds.

16. The vehicle of claim 15, wherein the notification indicates that additional input is required to open the profile session.

17. The vehicle of claim 16, wherein the profile session is a Message Access Profile session.

18. The vehicle of claim 16, wherein the profile session is a Phone Book Access Profile session.

19. The vehicle of claim 16, wherein the additional input comprises an indication that the profile session is permitted.

20. The vehicle of claim 16, further comprising a display, wherein the notification is displayed on the display.
